(19) United States
(12) Patent Application Publication
(10) Pub. No.: US 2024/0015342 A1
(43) Pub. Date: Jan. 11, 2024

(54) SELECTIVE AUTOMATIC PRODUCTION AND DISTRIBUTION OF SECONDARY CREATIVE CONTENT

(71) Applicant: FUTURI MEDIA, LLC, Seven Hills, OH (US)

(72) Inventors: Craig BOWMAN, Durand, MI (US); Daniel ANSTANDIG, Bay Village, OH (US)

(21) Appl. No.: 18/279,919

(22) PCT Filed: Mar. 1, 2022
(86) PCT No.: PCT/US2022/018302

§ 371 Date: Sep. 1, 2023

Related U.S. Application Data
(60) Provisional application No. 63/155,397, filed on Mar. 2, 2021.

(51) Int. Cl. H04N 21/234; H04N 21/2187; H04N 21/81; H04N 21/84; H04H 60/37

(52) U.S. Cl. CPC H04N 21/23424; H04N 21/2187; H04N 21/812; H04N 21/84; H04H 60/375

(57) ABSTRACT

The present invention provides to a web-based software and hardware system that act together with a user device to capture an audio feed, to easily encode and add meta data to the the audio content using input from studio systems, parse the content based on its type, and to provide the means to incorporate a feed segment produced from the encoded audio feed into a secondary production which is used to provide an indexed archive of audio and on-demand broadcast content, for example, by the creation and publication of pod-casts or on-demand broadcast, which is automatically filtered according to instruction relating to copyrights and which is dynamically served.

### FIELD OF THE INVENTION

The present invention relates to a web-based or downloadable software and hardware system and method for their use, that act together to record and filter live audio stream feed, to mix that with pre-recorded content for re-packaging with meta-data and selective transmission and distribution of that creative content, such as for broadcast audio or for social media platform distribution. Further, the invention is used to produce on-demand broadcast content which can be selected or filtered, such as for compliance issues, and tailored for distribution such as on social media, RSS, and to create sharable content.

### BACKGROUND OF THE INVENTION

Broadcast radio has historically been a highly regulated industry which delivers audio content at specified wavelengths so as to require receivers tuned to receive a specific signal. This originally included predominately live production of content including a live radio audience. The industry has strived to retain the audience excitement provided by real-time broadcast as it is evolved to incorporate pre-recorded or pre-programed content, including elements such as music, sound effects, laugh tracks and applause to name a few.

Traditional broadcast radio spends billions of dollars creating millions of hours of creative audio content that is only used once. Generally this happens in the context of a portion of a show involving broadcast talent (i.e., a disc jockey or “DJ”), including, for example, a live audio or audio and video stream, typically created in analog form, that is captured as a linear stream by means of a microphone and studio production equipment for simultaneous broadcast or for capture as a file, and later broadcast as is or subsequent to editing, often including selected portions of songs captured with the live voice over. While period for such streams within an hour or two hour show may include breaks for commercial interruption, the length of the streaming periods renders them virtually useless to rebroadcast as clips of less than 2 minutes, for example, since the content is un-searchable and un-cataloged. In the past, audiences have had limited access to previously broadcast content, subject to what was available in real-time over the air. The use of the internet, the acceptance of social media, and the prevalence of mobile devices that allow instant connectivity has hastened the evolution of the broadcast industry and linked it to alternative content platforms with differing rules of engagement.

The assignee of the present invention has enabled a hardware and software system for the parsing, identification, indexing manipulation of the live stream content, including re-mixing captured content with pre-existing pre-recorded or even simultaneous content to create new content. In addition, that system allows for the distribution of that content to other broadcast or publication platforms, including, for example, social media, such as FACEBOOK, INSTAGRAM, TWITTER, TIKTOK, IHEARTRADIO, PINTEREST, to name a current few. That system allows broadcast talent, such as the production manager or DJ and/or a user including a station administrator, to instantly (including in real-time) mark, such as by marking or encoding using a marker, (such as a tone, a General Purpose Input/Output (GPIO), a virtual marker, or other energy wave form), a desired portion of the stream and to automatically (meaning without the direct aid of a human editor) decode, convert, parse, sort, and compile, combine or edit all of or portions of the streaming broadcast content (as clips) and to preserve or incorporate selected advertising material according to preset instructions entered into the system software by an administrator, for example entered using a dashboard on a display device to access a sub-program which directs the system to act automatically for present or future production (termed herein “user enabled instructions”) into an secondary experience, including an on-demand experience. Thus, the invention allows broadcasters to leverage the streaming experience and to easily capitalize on the additional audience and advertising revenue opportunities for the pod-cast or on-demand audio markets, as well as through social media. In addition, the invention allows for a “proof of performance” or validation of the listener or more broadly audience experience of content by tabulating or indexing the quantity of advertising material served into a secondary production and the quantity and quality of distribution, for example on a station web-site, through downloads, or through social media.

The system includes an encoder or marker, which marks the recorded stream. In addition, a “touchscreen” is included, for example, a tablet including a dedicated dashboard that presents the feed stream as a visual, such as a waveform which may be marked by time and expandable to show the details of the audio such that on-air talent can generate a feed clip from the live audio stream.

The system also includes a clearance component that uses a prioritized approach to determining if the captured dynamic content is free from copyright or other compliance issues. For example, if the feed stream includes a playlist that is generated by a broadcast automation system, or by a broadcast administrator, it will generally include metadata as to on-air selections. The clearance component of the present invention can review the metadata to determine if there is inclusionary material, such as copyrighted or potentially prohibited material, which needs further clearance analysis. The clearance component can review the selection rules selected by the operator to determine whether to clear questionable material or not. An example of this is a determine on performance rights for music as it relates to specific listeners or audiences, such as large performance rights or individual licensed use. Alternatively, the clearance component could determine if the subject matter or language was within defined age-related parameters or for reasons which could be considered to be inflammatory.

Following the metadata analysis further techniques can be used by clearance purposes. The dashboard waveform or other audio fingerprinting techniques can represent a visual representation of the audio component of dynamic content represented by the generated feed stream clip that can be a or the item automatically screened to filter out copyrighted material in the dynamic content based on inclusion criteria selected by a user in the automatic production of the secondary content.

The filtered feed clip is subsequently combined by the software and hardware production portion of that system such as into a prepared template optionally accessible and manipulatable through a broadcast station automation system or the display associated therewith. The cleared feed clip can be combined in the production system production with additional material again in accordance with pre-set administer or “user enabled instructions”. The additional material includes transcription, music or other audio selections, promotional material and advertising, and associated “metadata” to produce an instant on-demand segment or pod-cast, (i.e., “a secondary production”) from a last talked break. Once again, the transcription can also be subject to review by the clearance component to ensure it is clear for use. Thus, in a matter of seconds, stations can take a live show segment, including automatically, and turn it into a pod-cast on social media, including iTunes, Facebook, Twitter, the station web-site and a number of other platforms, such as iHeartRadio, ITunes, and similar services.

In certain aspects of the technology disclosed, the production system may be configured to incorporate a feed clip into a secondary production by including one or more of promotional material advertisements using an ad invocation. In certain aspects, the production system is configured to invoke an external advertisement service to provide, including to automatically provide without human intervention at this point in the process, and based on a call/request/ad invocation based on user enabled instructions entered using a touch display and/or keyboard to access a software program that instructs the system to act. In this case, the supplemental material is provided to the production system with at least one promotional material advertisement which is included, e.g. automatically included, in the secondary production by the production system according to pre-set criteria entered through the software or live time prior to distribution. In certain aspects, external advertisement service may be invoked by the production system according to a set of user enabled production instructions in form of machine readable code executed by, or available to, the production system. In the context of the system and methods of the technology disclosed, user enabled production instructions may be a sub-program which is configured to securely direct the system to act automatically for present or future production and/or distribution.

The content is gathered from analog or digitally encoded real-time audio which includes embedded markers to facilitate parsing or indexing or organization of the content, and which can be combined and transmitted with further information, content or data, including metadata, to form revitalized content or compilation as a secondary production for further distribution and publication or broadcast. The act of parsing produces a segmented feed stream which typically has from 0.25 to 30, and preferably from 0.5 to 10, and most preferably 5+/−2 second segments. The length of the segments can be determined based on the internet speed and the content so that the segment provides an amount of material appropriate for communication and download. The further included information or “metadata” is data or information that provides information about other data such as generalized information about music artist or licensing information or in the case of ad invocation, about the advertising material. The content can also be evaluated, by the production and distribution system of the present invention such as by searching or filtering the content through use of the metadata or by other means, including for example, audio fingerprinting techniques that can be used to identify content segments that might be subject to unlicensed copyright use or otherwise desirable for segregation out of the content.

The content may also be available or made available via a web-based interface for searchable access by the broadcaster, their affiliates, or audience. The system further provides on-air talent, and producers with the ability to mark selected content (in and out) control content, zoom in and out, fade, combine and layer audio, and visual content, use templates, such as for recurring content, and edit items that can also be set to default, including, for example, title, description, images, and bumpers so as to enable the talent to post, publish or broadcast by simply editing the audio feed and clicking to post. The production and distribution system of the technology disclosed may include a streaming transmitter having an architecture that includes hardware and software, where the software system may be a machine bearing machine readable code that may be interfaced by automated administrator or a live administrator using a touch screen and/or a keyboard.

A concern that has been high-lighted in the creation and distribution of this newly created, but recycled content is remaining clear of the legal rights of others, including infringement of intellectual property, and specifically copyright, but potentially also including trademark, privacy, and libel and slander, and communication mis-doings, such as the inclusion of knowingly unreliable statements or inappropriate content. Social media platforms each have individual rules for the inclusion of information, including for example, provision for payment of audio or visual licensing fees to avoid problems with copyright or trademark infringement, or meeting impositions as to truth or first amendment freedoms of expression. The clearance component can have pre-set rule templates to account for the individual rules of each of these social media platforms.

The present invention provides an advantage over the prior art in allowing for a hardware and software method to selectively filter, mix and transmit or distribute revised content with metadata 1) such that the revised content is appropriate for each specific platform and 2) is free from content, such as unlicensed copyrighted material, that could cause problems for each platform with the regulations, rules and the rights of others.

### SUMMARY OF THE INVENTION

The present invention provides for the collection, and selective aggregation and separation of creative content, such as an audio data file, for the creation, transmission, storage and distribution system with a production system or subsystem that allows the real-time marking or even selection (for example, in real time) of content including both analog and digital content. The invention further provides for the integration of a streaming transmitter in which a hardware marker or encoder at a local station presents an audio data file analog to an analog to digital converter. The feed stream can be provided into identifiable streams with markers to allow automated re-use with a reduced risk of problems such as copyright infringement, and for automated incorporation into compliant content for distribution to a wide variety of platforms.

A production sub-system of the present invention allows a marked segment selection of a feed stream, including an audio feed to be subsequently displayed visually on a display screen or presented as part of production that may be at least one of parsed, decoded, filed, stored and marked for further use in the production subsystem, which may automatically edit and include the selection in combination with internally or externally provided material (i.e., by a live administrator, and automated system or an external advertising service that stores and delivers ad content) that is similarly filed, stored and marked as to content, such as promotional material, or commercial material, or even including video content or visual content. As a further aspect of the invention, the feed stream may be screened at any point during the production and distribution process to mark and filter or parse out prohibited content, again, in accordance with the user generated instructions. The marked selection may also be transcribed and the transcription can be used, for example for archiving, indexing, or searching or filtering in accordance with the invention. The production subsystem enables a producer (i.e., a human or machine-based decision maker, including a broadcast station automation system) to create new content events or secondary production, and more specifically, audio-based events (which may include embedded graphic or video content), such as on-demand segments or pod-casts which represent sequences of audio with additional information, such as meta-data or other information, includable searchable information or analytics for cataloging or copyright licensing purposes and which optionally, may be formatted and distributed according to pre-selected criteria, including for example demographics and which are subsequently used as directed in subsequently broadcast, pod-cast or on-demand application.

The production sub-system includes a software and hardware filtration device that selectively, and in accordance with a automation sub-routine, divides and identifies potentially prohibited material, including, for example, material that is subject to copyright or material that is inflammatory or for which the truth can not be verified. This allows that material, for example, a selected audio stream or channel within a larger aggregation to be eliminated from the larger creation. Thus, the production sub-system can tailor the new content in accordance with instructions so that the same content can be mixed for specific platforms. Thus, copyrighted music segments can be used for platforms which have existing agreements with ASCAP and can be filtered out downstream of the feed stream for platforms which do not have such agreements.

File storage and communication is secure and takes place behind protective means with appropriate secure measures including, for example, fire-wall and/or encryption protocol, and the invention provides for library services with respect to the initial content and for the edited version as well. An example of a mechanism for accomplishing this includes HTTP Live Streaming (HLS) style manipulation, but used for audio or audio and video, in which HTTP file transfer technology is used to transfer the feed segments to the cloud or other secure remote or in-house file locations. The communication and file resides in the cloud and is accessible using secure communication means optionally accessible by the service provider and by the content provider.

### BRIEF DESCRIPTION OF THE DRAWINGS

FIG. 1 is a schematic view of the invention;

FIG. 2 is a schematic view of the system components;

FIG. 3 is a flow chart of the streaming transmitter of the present invention;

FIG. 4 is a view of the dashboard showing the view of a waveform of the feed stream of the present invention; and

FIG. 5 is a view showing the production and distribution sub-system to reduce potential infringement problems in re-created creative content.

### DETAILED DESCRIPTION OF THE INVENTION

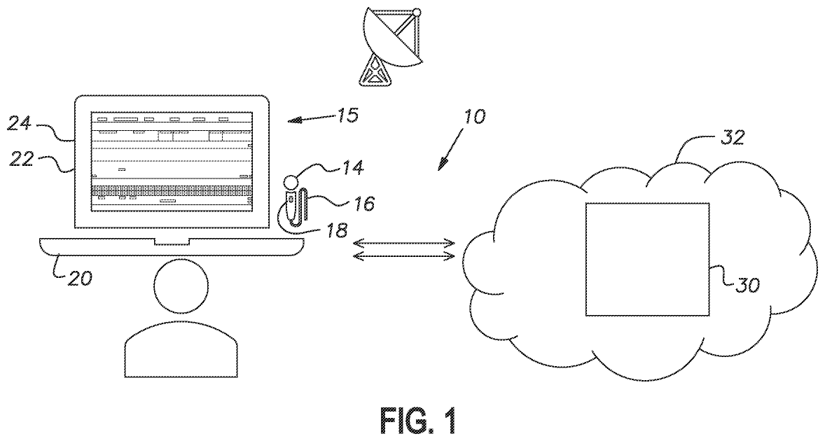

FIG. 1 shows a schematic view of the production system in accordance with the present invention in the context of the interaction between the external stream source, i.e., the broadcast station or broadcast automation system, and specifically, the secondary product production system, and the content provider feed stream or broadcast automation system. While the invention is described with respect to a separate and external secondary production system (i.e. which is implemented and managed apart from the broadcast station), it should be understood that the stream and production system source can be internal to the broadcast station and operate as part of the automation system and where the link of the present invention is used as a platform or mechanism to import either files external to the, file system, and/or automation system or to determine content to be placed into a file or location in existence in the automation system playlist or selection sequence. File storage and communication is secure and may take place behind with appropriate secure measures including, for example, fire-wall and/or encryption protocol, and the technology disclosed may also provide for library services with respect to the initial content and for the edited version as well. As mentioned-above, example mechanisms for accomplishing this include HTTP Live Streaming (HLS) style manipulation, but used for audio or audio and video, in which HTTP file transfer technology is used to transfer the feed segments to the cloud or other secure remote or in-house file locations. HLS is an HTTP-based media streaming communications protocol that works by breaking the overall stream into a sequence of small HTTP-based file downloads, each download loading one short chunk of an overall potentially unbounded transport stream.

By way of non-limiting example, various components are described and shown, which may perform various functions and interact with each other. These components may be segregated based on their function merely for the sake of description and may represent computer hardware and executable software code which may be stored on a computer-readable storage medium for execution on appropriate computing hardware or mobile devices. The various functions of the different components may be combined or segregated as hardware or software stored on a computer-readable medium in any manner, and may be used separately or in combination.

The present invention provides a system for creating and providing a downloadable secondary production to a presentation device of a user, and the system 10 includes a capture system 12 which is exposed to a feed stream 14, such as a live talk break of a broadcast radio station 15. The capture system 12 has a encoder which is a GPIO device, such as an encoder or microphone 16 that is activated, for example by a kill switch 18 pressed to on to begin a recording session and to off to end a recording session. Other marking systems could also be used, including a undetectable marked transmission of noise, or lightwaves. The capture system thus records talk breaks as a linear feed stream, which can be converted to digital stream or recorded as analog. The system further includes an encoder 20 which in this case is enabled by a controller, i.e. a tablet computing device 22, which also has a web-based administrative control panel controlled using user based instructions, and typically displayed on a dashboard 24 (i.e., an admin panel and which may be secure such as by firewall and other software and passcode protections). As a further aspect of this invention, the capture system may include multiple microphones which each supply a feed stream, for example as a series of feed channels, which can subsequently be combined with additional material from additional feed sources or channels. This includes music, sound recordings, phone conversations, audience interaction, live conversation, virtual or internet presence. Each channel includes metadata to mark the stream, which allows for indexing, identification, filtering and selective addition or elimination from newly created content. This feature allows an automated combination and transmission or distribution of content that ensures appropriate distribution, for example to avoid copyright infringement where licensing rights are not secured for content used.

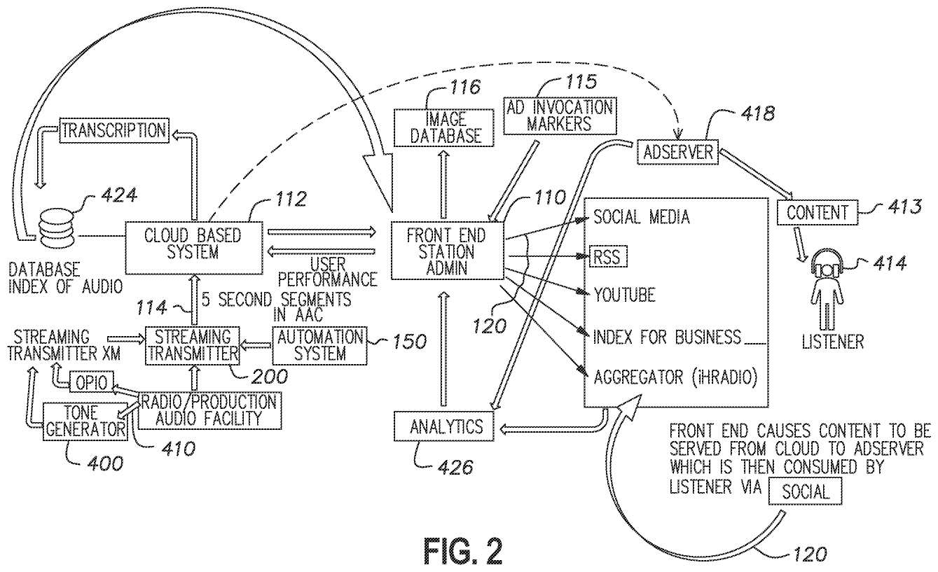

FIG. 2 illustrates the components of an example implementation of the present system 100 which is accessed through a front-end user 110, or station administrator which or who enters criteria to control variables within the production process. In this implementation, a cloud based production system 112 is linked through the internet to a feed stream 114 and receives an encoded feed stream 116 which has been marked and thereby parsed, for example using the microphone with a kill switch, where the encoder will mark the feed stream in 0.25-30, and preferably 0.5 to 10, and most preferably 5+/−2 second segments for later use. The production system illustrated in FIG. 2 may be configured to act on the marked segmented feed stream by indexing, and transcribing the feed segments and by dividing the feed stream into channels as appropriate and which are linked back to the station administrator 110 which may add supplemental material including visual material such as jpegs, pdf, video, or advertising material using an image data base 116 and/or an ad invocation service 118. In example embodiments, at least one of the image database and the ad invocation service is part of a content insertion system which is linked to the production system and which is configured to incorporate additional content to the secondary production.

An analytic system 130 may also be linked to the production or distribution system 120. The analytic system 426 may account for the content insertion into the secondary production. This can occur automatically, according to pre-arranged instructions, or during re-broadcast with the help of human intervention. The analytic system 130 includes a clearance component 131 which applies user selection rules to determine if the dynamic content is cleared for use, and if so, where it may be distributed since it is possible to be cleared for some, but not all distribution channels. The clearance component may be similar to the copyright clearance invention of Audible Magic Inc., described in U.S. Pat. No. 10,025,841 to Schrmepp; US Pat. Pub. No. 2017/0169235 to Schmelzer and assigned to Audible Magic Corporation; US Pat. Pub. No. 2019/0028766 to Wold et al. and assigned to Audible Media Corp.; and US Pat. Pub. No. US2019/0205467 to Wold et al., and assigned to Audible Magic Corp. which are incorporated fully herein as if set forth herein.

The production component in FIG. 2 may be linked to a distribution system 120 which is directed by the station administrator where to distribute the secondary production (i.e. the material represented by the selected marked segments and added additional material including the visual material, advertising material, and metadata). The distribution system directs the secondary production to locations which can be accessed by the ultimate audience member on a mobile, lap-top or desk-top or other dedicated device, i.e., through a broad-cast station web-site, pod-cast, or through social media services. In certain aspects of the technology disclosed, the front-end 110 may cause content to be served from the cloud-based production system 112 directly to an ad server 418, which is then consumed by listener via social media. The filter may happen at the back-end of the production system as well. An ad server is typically a web server that stores advertising content used in online marketing and delivers that content onto various digital platforms such as websites, social media outlets and mobile apps. An ad server is merely the technology in which the advertising material is stored and is the means of distributing that material into appropriate advertising slots online.

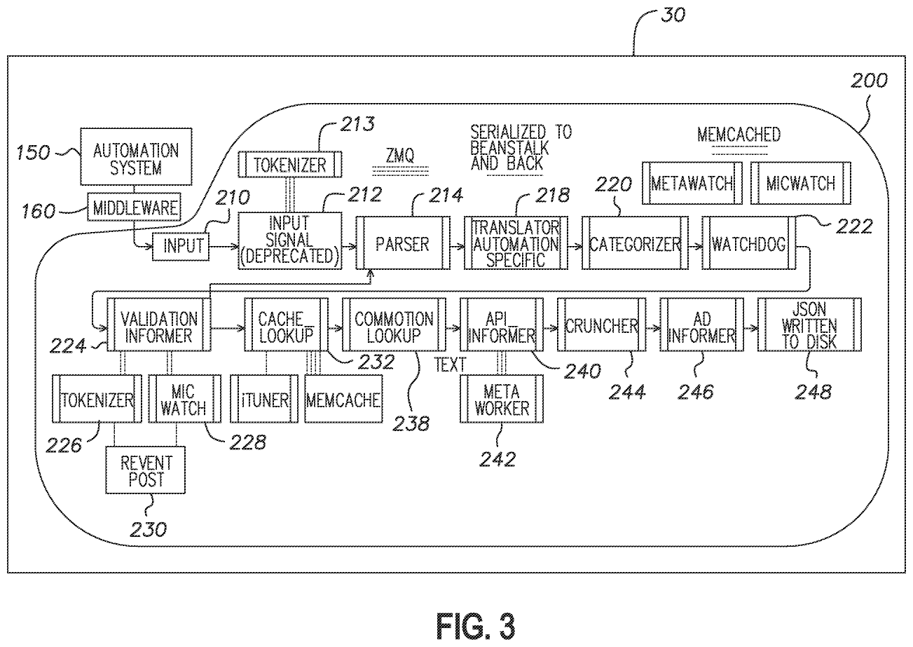

FIG. 3 illustrates a streaming transmitter system 200 that interfaces with a broadcast automation system 150 by a middleware system 160 and for use with the systems shown in FIG. 2, and comprises an input 210 that receives analog audio and AOPIP through Livewire and NOW PLAYING information, which includes UDP, such as raw text and XML, and TCP, such as raw text and XML. This input may be segregated into component feed streams or channels for identification and use at a later point.

This is fed to a Input signaler 212 which validates the Now Playing input signal through a tokenizer 213 and forwards it to a Parser 214 which acts to parse the NOW PLAYING or metadata into items such as title, artist, automation ID, length in seconds, automation category, aired time and album art. This information is fed to a Translator 218 which translates the automation categories into groups, where the automation system may have several categories used for music and the categories are associated with a group named Music. The Categorizer 220 takes the translated groups and categorizes them as to whether they should take priority of the subsequent group. For example, if an announcer is talking and a song starts before the microphone is turned off, the beginning of the song segment is pushed, in time, until the microphone GIPO is turned off. The Watchdog 222 uses logic to detect talk breaks/phone calls/non-automation events when there is no GPIO present. The validation informer 224 communicates with a tokenizer 226 and a mic watch 228 and REvent POST 230 to filter superfluous or unused material. A cache look-up 232 communicates with iTunes and a memcache for streaming and feds the material to Commotion look-up 238, a third party integrator for streaming audio or video material, which communicates with an API informer 240 that has a metaworker 242 and acts to communicate information, including album art, metadata and mic events to the POST system. A cruncher 244 creates a JSON blob of all of the metadata and sends it to the server. An ad informer 246 changes the state of a bit in a frame header to indicate that it is a portion of the stream which can be replaced by an external system for streaming. The JSON written to disk service 248 is used for streaming metadata and synchronization and the ReVent POST forwards raw data events to the API for processing.

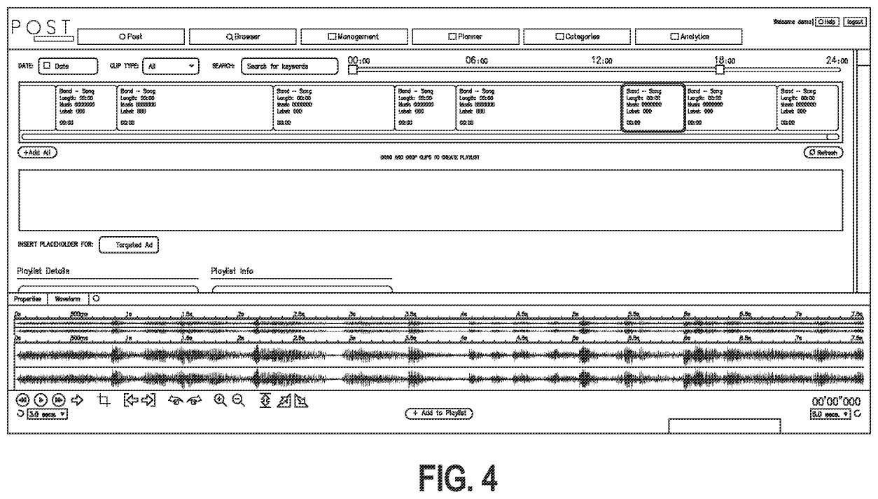

The dashboard, as viewed in FIG. 4 allows an authorized administrator to make changes to which feed segments are visible to each individual user on the system. The “administrator” is a set of instructions or person who is up-stream of the feed clip collection and production process and has the ability to take control of this process, whereas a “user”, and in particular an “end-user” may also be an audience member, ie., an entity or person downstream, who may participate in the social web-site or media based communications or to whom the results of the inventive process (i.e. the pod-cast or on-demand segment) is supplied on a device. The web-based admin control panel also includes options to override the automatic production of the new material to create the secondary production, where an administrative user may edit, combine or merge or un-merge certain items out of a template production including directions to the clearance component. The encoder 20 is a tone generator which may be configured to generate a tone which is in-audible to the final audience. The tone generator may also be configured to add undetectable marked transmission of noise. The invention also includes a production system 30, which is hardware having machine readable code and the code, or software system, which preferably resides in the cloud 32 but which interfaces with the capture system by means of the internet.

Using a web-based admin control panel, the broadcast station administrator can also add new sources for the production system to collect additional information for the final production, for example, a report on the weather in a specific location, or the top song of a particular genre.

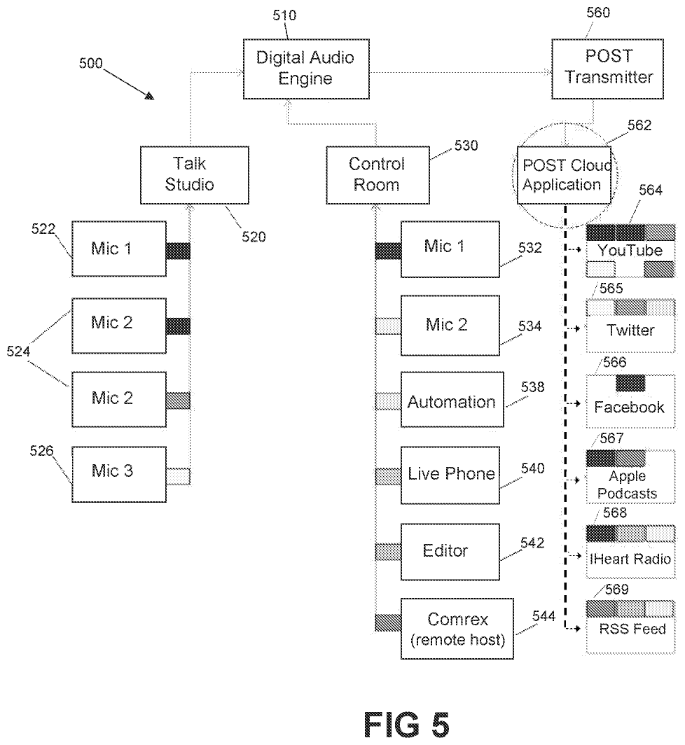

FIG. 5 shows an illustrative diagram of the sub-production, distribution and transmission system 500 of the present invention. In this diagram, this system 500 is show as including a digital audio engine 510 which receives selected content from various sources, including a talk studio 520 which in this instance receives content from three microphones, 522, 524, 526, and a control room 530 which also receives content from a number of sources, including two microphones, 532, 534, from an automation device 538, from a live phone receiver 540, from an editor source 542, and from a remote host, 544, such as a comrex. The content is received in the production system where it is reviewed, associated with the metadata or “fingerprint” or wave form identifier which can be used for evaluation as to whether the content meets selection criteria or whether it needs to be subject to be screened for elimination of de-selected material, such as might be problematic due to copyright or other concerns. Further analysis may include review of transcriptions, such as of lyrics or spoken word, for example against known databases of copyrighted material that are held in copyright offices or through public or private databases. The indexed and tagged content passed to the production transmitter 560 and to a cloud application 562 for distribution to various platforms, including, for example, YouTube 564, Twitter 565, FaceBook 566, Apple Podcasts 567, IHeartRadio 568, and RSS Feed 569.

The system may use ad invocation. In the past, advertisers have only been able to participate in the linear live part of the broadcast, but advances have permitted advertisers to select different target listener and different part of broadcast in which to place advertisements. For example, ads directed to 13 years olds for a part of a pod-cast or 60 year olds for another part. This alleviates the former practice of having one standard place for ad insertion and allows for dynamic ad insertion in which segmented audio is available to advertisers, and which can be inserted at any point. Moreover, the technology disclosed may enable the broadcaster to validate or prove where ad content was listened to, i.e. as a proof of performance for the ad and for the content both, since the ad streams via HLS can identify where the ad was listened to. The marked 5 second segments feed stream allows the insertion at a different place since there are 5 second segments between and the ad has to be served via ICEY stream, whereas a regular pod-cast to an advertiser has a beginning and an end. The present invention is like a play-list with multiple entries because it actually serves an advertisement and the serving can be verified to confirm what was served and listened to based on back-end insertion technology and using a dynamic ability to serve the advertisement or supplemental content.

In certain aspects, the technology disclosed relates to a production system for creating a secondary production in form of an audio clip, or a multimedia clip, with audio content from a live feed stream. The production system may then be configured to receive a marked segment of a live feed stream and may comprise a machine with machine readable code configured to parse, or index, the marked feed stream into a feed clip and which is further configured to incorporate the feed clip into a secondary production by combining the audio content of the live feed stream with at least one of searchable and/or filterable metadata, one or more promotional material advertisements and supplemental content in different format, including video or graphic files.

In other aspects, the technology disclosed relates to a capture system receiving a live feed stream comprising at least audio content, where the capture system further comprises a marker device for encoding, in real-time, a segment of the received live feed stream by marking the segment with a marker in form of at least one of an in-audible tone, noise and/or a lightwave. By marking the segment of the received live feed stream, the marked feed stream may be adapted for subsequent parsing, or indexing, into a feed clip by the machine readable code of a machine of a production system to which the marked feed stream is transmitted.

In certain aspects, the technology disclosed relates to a system for creating a secondary production in form of an audio clip, or a multimedia clip, with audio content from a live feed stream using a marker device and combining the audio content with additional material, the system comprises: a capture system 400 configured for receiving a live feed stream 410 comprising at least audio content, where the capture system further comprises a marker device for encoding, in real-time, a segment of the received live feed stream by marking the segment with a marker in form of at least one of an in-audible tone, noise and a lightwave; and a production system 420 configured for receiving the marked segment 412 of the live feed stream 410 and comprising a machine with machine readable code configured for segregating, dividing, parsing, or indexing, the marked feed stream into a feed clip and incorporating the feed clip into a secondary production by combining the audio content of the live feed stream with at least one of searchable metadata, one or more promotional material advertisements and supplemental content in different format, including video or graphic files.

This system also performs selective review of content to eliminate material which is defined as sensitive material. The nature of what sensitive material is can be automatically determined by the system through the application of the filtering system of the present invention and in accordance with a set of administrator instructions. These instructions may be used to filter material which is subject to copyright and not authorized for further use, to eliminate libelous, triggering or inflammatory subject matter or material or language which falls outside an age related set of ratings. Thus, the invention reduces the possibility of copyright infringement or other potential legal infractions, such as invasion of privacy or violation of libel or slander or requirements for truth in publication, or to produce material which meets certain parental criteria, or avoids sensitive issues. In embodiments, the production system is further configured to create the above-mentioned secondary production or content 413 to be available for at least one of download and streaming to a user device 414. In certain aspects of the technology disclosed, the production system may be provided with pre-set administer or user enabled instructions 416 and may be configured for combining the content of the marked segment of the live feed with additional material again in accordance with the pre-set administer or user enabled instructions. In other aspects, the additional material may include transcription, music or other audio selections, promotional material and advertising and the production system may be configured to produce at least one of an instant on-demand segment or pod-cast. The benefits of using the system of the technology disclosed, which enables marking of a live feed stream and then parsing, or indexing, the marked feed stream into a feed clip by also incorporating additional material, may include that a broadcast station may take a live show segment and turn it into a pod-cast on social media in a matter of seconds, where the pod-cast may include transcription, music or other audio selections, promotional material and advertising. In certain aspects, the system is configured to create a pod-cast that, in addition to the original audio content of the marked segment of the live feed stream, also includes at least one of transcriptions, music or other audio selections, promotional material and advertising. In embodiments, the production system may be configured to act on the marked feed segment by indexing, and transcribing the marked feed segments, which are linked back to the station administrator, which can add supplemental material including visual material such as jpegs, pdf, video, or advertising material using e.g. an image data base or an ad invocation service. The production component may be linked to a distribution system 120, which may be directed by the station administrator 416 where to distribute the secondary production. The production component may also be used to establish validation or proof of performance of content, including ad content served from an outside source 418, for example through ad invocation.

In certain aspects, the technology disclosed relates to a method for creating a secondary production in form of an audio clip, or a multimedia clip, with audio content from a live feed stream by using a marker and combining the audio content with additional material, the method comprising: receiving, at a capture system, a live feed stream comprising at least audio content; encoding, in real-time using a marking device, e.g. a tone generator, a segment of the live feed stream by marking the segment with a marker in form of at least one of an in-audible tone, noise and a lightwave, where said marker is embedded into the feed stream to facilitate the parsing of the content of the feed stream; receiving, at a production system, the marked segment of the live feed stream; and identifying, reviewing, parsing, or indexing, by using machine readable code of a machine of the production system, the marked feed stream into a feed clip; and selectively incorporating, by using machine readable code of the machine of the production system, the feed clip into a secondary production, where the above step of incorporating the feed clip into the second production further includes incorporating additional material in form of at least one of searchable metadata, one or more promotional material advertisements, and supplemental content in different format, including video or graphic files, and wherein said secondary production is created to be available for at least one of download and streaming to a user device. In certain aspects of the method of the technology disclosed, the feed clip may be combined in the production system production with additional material again in accordance with pre-set administer or user enabled instructions. In other aspects, the additional material may include transcription, music or other audio selections, promotional material and advertising to produce at least one of an instant on-demand segment or pod-cast. An example advantage of using the method of the technology disclosed, enabling marking of a live feed stream and parsing, or indexing, the marked feed stream into a feed clip by incorporating additional material, may include that broadcast stations may take a live show segment and turn it into a pod-cast on social media in a matter of seconds. In certain aspects, the method of the technology disclosed provides a solution for instantly creating a pod-cast, i.e., dynamic content, from a live show segment that may, in addition to the original audio content of the marked segment of the live feed stream, also include at least one of metadata, transcriptions, music or other audio selections, promotional material and advertising. In embodiments, the method of the technology disclosed may include acting on the marked feed segment by indexing, and transcribing and by reviewing, clearing and filtering the marked feed segments, which may be linked back to the station administrator, which can add supplemental material including visual material such as jpegs, pdf, video, or advertising material by using e.g. an image data base or an ad invocation service.

In an exemplary data processing system upon which the methods and apparatuses of the invention may be implemented, the hardware of a capture system may be one and the same with the hardware of the production system, and may be individual desk-top or mobile based devices or may be cloud based devices accessible through a user interface device. It will also be appreciated that network computers and other data processing systems, which have fewer or more components, may also be used and may exist as individual components or as components of a larger system connected through the internet or the cloud. The data processing system of the present invention may, for example, be a workstation, or a personal computer (PC) running a Windows operating system, or an Apple Macintosh computer. As an example of the individual hardware (which may be considered as to the architecture in the event that the components reside in the cloud) with which the present invention can be used, the data processing system includes a system bus coupled to a microprocessor, a ROM, a volatile RAM, and a non-volatile memory 424. The microprocessor, which may be a processor designed to execute any instruction set, is coupled to cache memory. The system bus interconnects these various components together and also interconnects components, to a display controller and display device or other input devices including AI or voice activated assistants, and to peripheral devices such as input/output (I/O) devices, such as keyboards, modems, network interfaces, printers, scanners, video cameras and other devices which are well known in the art. Typically, the I/O devices are coupled to the system bus through input/output controllers. The volatile RAM is typically implemented as dynamic RAM (DRAM) which currently requires power continually in order to refresh or maintain the data in the memory. The non-volatile memory is typically a magnetic hard drive or a magnetic optical drive or an optical drive or a DVD RAM or other type of memory systems which maintain data even after power is removed from the system. Typically, the non-volatile memory will also be a random access memory although this is not required. While it is illustrated that the non-volatile memory is a local device coupled directly to the rest of the components in the data processing system, the present invention may utilize a non-volatile memory which is remote from the system, such as a network storage device which is coupled to the data processing system through a network interface including for example through the “cloud”. The system bus may include one or more buses connected to each other through various bridges, controllers and/or adapters. The 1/O controller may include a USB (Universal Serial Bus) adapter for controlling USB peripherals, and/or an IEEE-bus adapter for controlling IEEE-peripherals.

It will be apparent from this description that aspects of the present invention may comprise in software, hardware, firmware, or in combination thereof. Further, the invention may be executed using a computer system, tablet, PDA, phone, television or other data processing system in response to its processor, such as a microprocessor, executing sequences of instructions contained in a memory, such as ROM, volatile RAM, non-volatile memory, cache, or a remote device. In various embodiments, hardwired circuitry may be used in combination with software instructions to implement the present invention. Thus, the invention is not limited to any specific combination of hardware circuitry and software or to any particular source for the instructions executed by the data processing system. In addition, throughout this description, various functions and operations are described as being performed by or caused by software or by hardware so as to simplify description. However, it will be understood that the functions result from execution of code by a processor, such as a microprocessor.

The invention also relates to the aggregated apparatus for performing the operations of the invention. This includes the encoder, which is a piece of hardware that marks the stream, and that may for example, be included with the microphone 16, or which may be a separate piece of equipment. This apparatus may be specially constructed for the invention, or it may comprise a general purpose computer selectively activated or reconfigured by a computer program stored in the computer. This computer program may be stored or transmitted in a computer-readable medium which can be used to store software and data which when executed by a data processing system, such as data processing system, causes the system to perform the various tasks of the present invention. This executable software and data may be stored in various places including for example ROM, volatile RAM, non-volatile memory, and/or cache. All or part of this software and/or data may be stored in any one of these storage devices. A computer-readable medium may include any mechanism that collects or provides (including for example, storing and/or transmitting) information in a form accessible by a machine such as for example, a computer, network device, personal digital assistant, tablet, phone, manufacturing tool, camera, or any device with a set of one or more processors. For example, a machine readable medium includes recordable/non-recordable media such as, but not limited to, a computer-readable storage medium (e.g., any type of disk including floppy disks, optical disks, CD-ROMs, and magnetic-optical disks, read-only memories (ROMs), random access memories (RAMs), EPROMs, EEPROMs, flash memory, magnetic or optical cards, or any type of media suitable for storing electronic instructions), or a computer-readable transmission medium such as, but not limited to, any type of electrical, optical, acoustical or other form of propagated signals (e.g., carrier waves, infrared signals, digital signals, etc.).

Additionally, it will be understood that the various embodiments described herein may be implemented with data processing systems, which have more or fewer components than the illustrated system. For example, such data processing systems may include a cellular telephone or a personal digital assistant (PDA) or an entertainment system or a media player or a consumer electronic device, each of which can be used to implement one or more of the embodiments of the invention. The algorithms and displays presented herein are not inherently related to any particular computing system or other apparatus. Various general purpose systems may be used with programs in accordance with the teachings herein, or it may prove convenient to construct custom apparatuses to perform the method operations. In addition, a variety of programming languages, structure and techniques may be used to implement the teachings of the invention as described herein.

Some portions of the detailed description as set forth above are presented in terms of algorithms and symbolic representations of operations on data bits within a computer memory. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. Further, it is understood that components of the invention may be subject to AI or machine learning, which allows the system to self-educate and improve the efficiency of various components of the system, including the analytic and clearance component, as well as the integrated distribution component.

It should be understood that throughout the description, discussions utilizing terms such as “parsing”, “encoding”, “decoding”, “filing”, “transmitting” “distributing”, “storing”, “filing”, “archiving”, “scanning” or “filtering” or “calculating” or “collecting” or “tabulating” or “categorizing” or “displaying”, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices and which enables the further use, such as by visual display.

The invention may include various operations as set forth above or more or fewer operations in an order, which is different from the order described herein so long as the end purpose can be attained. The described operations may be provided in machine-executable instructions, which cause a general-purpose or special-purpose processor to perform certain tasks. Alternatively, these operations may be performed by hardware components that contain hardwired logic for performing the operations, or by any combination of programmed computer components and custom hardware components.

Thus, the software system of the present invention system includes software that permits a radio station' studio or other media or digital publication platform automation system to interact via an external communication means such as the web, with a separate server which hosts the process of reception of the transmission of the marked feed stream including the feed clips, filing and storage of the feed stream (including for an extended period of time, such as 30-90 days or even 1 or 2 years) and of the feed clips, (likewise for a defined period of time, such as 30-60 days), and the secondary production creation and distribution. Specifically, the software monitors a definable location for production information, such as new log exports, which are generated by the radio station automation system or a music scheduling program. The system and methods of the technology disclosed allows for various features including ad invocation, transcription of the marked feed stream, analytics, proof of performance for content and inserted content such as ads, metadata attachment, combination of supplemental content in different format, including video or graphic files and linking to outside files. In aspects of the technology disclosed, a distribution system linked via an IP network to the production system may be used. In certain aspects, the distribution system may be configured to distribute a created secondary production in accordance with a set of user enabled instructions, “user enabled distribution instructions”, whereby the secondary production is available for download or streamed to a user device.

The broadcast station stream is captured by a marker device such as a microphone and is transmitted, or fed, to a production system that typically resides off location, such as part of a cloud-based production system. Thus a separate server advantageously conducts the marked stream induction and the station interface and stores the marked content. This hardware and software system receives data for the broadcast station, which it uses internally, manipulates, for example in accordance with an organizational scheme that has been previously set-up to parse, edit, combine, and compile contents to automatically produce a secondary production, which is then forwarded back to a station server separate server via a secure web-based API. The software queries the web-based API which provides XML data to convey the secondary production system using HTTP GET via TCP-IP which are sent back from the separate production system to the station software system, which copies the contents of the analog or digital secondary production file to a new file (“placeholder” file) using a file location, for example for publication on a station web-site, which causes the station automation system to import the secondary production file. The system is not limited to the use of a specific type of method of managing the file transfer and secondary production exportation and can encompass other methods of transferring information. To the broadcast radio station automation system or to social media, including, for example FaceBook, Twitter, Instagram, and Pinterest to name a few.

The software system of the present invention uses a surrogate or placeholder for a decoded feed clip with meta data which is an entry in a file which defines the template for the secondary production of the present invention and that will later be replaced by a feed clip generated in accordance with the present invention. The file is a text-based file which uses row and comma format for data that represents the on-air schedule for a broadcast station for a given period, such as a broadcast day. The invention subsequently copies the selection's file contents into this placeholder file to cause that selection to be incorporated into the template for the creation of the secondary production file.

The broadcast automation system generally sends the “encoded feed stream” data in a single format, but the software of the present invention has the ability to forward this information in a variety of different formats to multiple sources using a variety of protocols, such as XML over TCP/IP including metadata.

The software production system 10 of the present invention includes the following major components, each responsible for a separate process, that can be combined together to create the functionality required to enable the broadcast station automation system to make a secondary production available to an audience by on-demand, push to social media or down-loadable.

The first component is a component which receives and monitors a feed stream (transmitted from the broadcast radio station, for example, by means of the interaction of a broadcast interaction system), for the encoded section and which then creates a feed clip from the feed stream and decodes the feed clip to remove the marker, such as the in-audible tone that has been inserted by the broadcast radio station to book-mark a section of the live stream between mic on and mic off events. The system is set to recognize the mic on mic off events and uses these benchmarks to parse the clip, unless a different time period of begin and end are defined in the system. Examples of automation systems which can be used with the present invention include those manufactured by Scott Studios/dMark/Google/Wide Orbit as defined by these automation manufacturers. Other automation system manufacturer's music import format is likewise supported by the present invention.

As a second component, after the production system has received the live feed stream data from the broadcast station automation system 16, manipulated it by parsing it into feed clips as described, it optionally adds additional material in accordance with the instructions included in a pre-set template to make a secondary production. In this component, the feed clip is stored as a retrievable selection until it is copied and used. In this case, the production system follows live or pre-assigned instructions for example, to replace a placeholder file with the feed clip in a template that includes additional material, such as audio or video selections, graphic or visual content, promotional material or advertising. The additional material can be tailored for individual uses, including analytics, i.e. according to demographic definitions, such as the geographic location of a user or broadcast call sign, or the end use demographic for particular users or audiences. Alternatively, a producer can incorporate the feed clip into an entirely different secondary production which is not based on a template but created from scratch.

Embodiments are described for classifying media content items. A media content item may be audio (e.g., a song or album), an image, a video, text, or other work. Media content items may be files (e.g., audio files having formats such as WAV, AIFF, AU, FLAC, ALAC, MPEG-4, MP3, Opus, Vorbis, AAC, ATRAC, WMA, and so on, or video files having formats such as WebM, Flash Video, F4V, Vob, Ogg, Dirac, AVI, QuickTime File Format, Windows Media Video, MPEG-4, MPEG-1, MPEG-2, M4V, SVI, MP4, FLV, and so on).

Media content items may also be live streams of video and/or audio media. In embodiments, media content items are classified using media classification profiles derived from machine learning models.

In another embodiment, a media content item is provided to an input of one or more machine learning models in a media classification profile and determined to be of a classification which warrants additional processing, which elevates the processing of a transaction request to include processing techniques and/or methods utilizing additional resources. Additionally the classification may identify that the media content item has been obfuscated to hide the use of a known work.

As mentioned above, the system may also attach metadata, which can be used in accordance with the invention for the identification and de-selection of material that may be un-licensed copyright material. It has become increasing common for broadcast audiences to expect to get additional information, such as the “Now Playing” information relating to the Station ID, song title, and artist, displayed on late model vehicle entertainment systems. Metadata and actions via an identifier are typically used in the broadcast industry to link audio (namely audio signals, including music, sound tracks of audio and video or visual works, voice recordings, and other media objects including video, still images, and graphical models, etc. An identifier attached to an audio signal is used to connect that signal with metadata and/or programmatic or device actions. The terms “media object” and “audio object” refer herein to an electronic form of a media signal and audio signal, respectively. The linking of media signals applies to objects that are transmitted over wire networks (such as a computer network), wireless networks (such as a wireless telephone network), and broadcast (AM, FM, digital broadcast, etc.).

There are a number of ways to associate an identifier with an audio object, including the insertion in the form of a numeric or alphanumeric code (e.g., binary or M-ary code) in an electronic file in which the audio is stored or to associate the identifier by embedding it as auxiliary data in the audio signal using steganographic methods, such as digital watermarking or other data hiding techniques. Alternatively, the identifier can be derived from the audio signal, the table of contents, the file system structure, or its container (e.g., an electronic file or physical package for data like flash memory, Digital Versatile Disk (DVD), minidisk, or compact disk (CD). This physical media may have identifying characteristics, such as a unique identifier or encoded metadata, or other attributes from which an identifier can be derived (e.g., CD disk wobble).

When the identifier is associated with metadata or actions in this way, it transforms the media object into a “linked” object where the identifier travels with the object through distribution, including in some cases, through physical distribution in packaged media and through electronic distribution (broadcast or network communication). The identifier may travel within the same band as the audio object, such as a watermark, or via a separate band, such as a file header or footer or separate broadcast band. A decoding device or programmatic process extracts the identifier from the object and uses it to retrieve related data or actions (typically known in the industry as “metadata”). In the case of an audio object, like a song, the metadata often includes the title, artist, lyrics, copyright owner, sound recording owner, information about buying or sampling opportunities and URLs to this type of data as well as web sites and other programs and devices. Linked actions include device or programmatic processes for electronically establishing a license, transferring content (either streaming or download), sending an email, and recording marketing data about a transaction. The identifier allows an interested party to get more information about the music and to buy more music. From the perspective of the artists and record labels, the identifier provides an additional opportunity to promote their music and sell content and concert tickets.

In addition, in some implementations where identifier linking transactions are monitored, it enables the vendors of music to gather data about electronic transactions triggered by the link. For example, a user ID or other context information may then be recorded when the identifier is extracted and used to trigger a transaction. Artists can link their music to information about themselves and provide electronic buying opportunities for promotion of their music and associated merchandise. Rights holding organizations can use the link to monitor rights, licensing opportunities, and playing and distribution of copies of the music. Record labels can link their music to information about the artist, the label and electronic buying opportunities opportunities to to sample and buy additional music (via download or streaming delivery over a wire or wireless network). Broadcasters, including radio stations can use the linking capability to bring users to their web sites, creating advertising revenue, to provide electronic buying opportunities.

The identifier may identify the media object in which it is embedded, or entities, things or actions other than that particular media object. One type of identifier is an object ID that identifies an audio object. This identifier may be a number associated with the object, such as its International Standard Recording Code (ISRC). Another type of identifier is distributor ID that identifies the distributor of the audio object. Another type of identifier is a broadcaster ID that identifiers the broadcaster of the audio object. Of course, more than one identifier may be encoded into an audio object or its container. In the event that an object ID is not encoded with an audio object, but instead, a distributor or broadcaster identifier is encoded with the object, other context information, such as the time of play back or distribution or location of distribution, may be used to identify the audio object as part of the linking process. An example is a radio station that marks its broadcasts with a station ID and maintains a playlist database with the air times of each audio object. At decoding time, the station ID is extracted and used along with context information such as the air time of the audio object to look up the audio object or its corresponding metadata and actions. This approach enables the linking system to provide audio object specific metadata or actions even without requiring a unique object identifier in every audio object.

A third component of the system is a publication component that forwards the secondary production (or a link to the secondary production) to the broadcast radio automation system via a web-based API. The information is formatted, for example in XML, and transferred via a TCP/IP connection as a stream of bytes. In one embodiment, a software linking system re-formats this secondary production data, and sends it to the system via HTTP POST via a web-based API. The data is sent along with authorization credentials (username and password) for security. The HTTP POST parameters used by this API are:
stationId—A string of characters that identifies the station to the audience participation system
auth_username—A string of characters representing the username used for authentication
auth_password—A string of characters representing the password user for authentication
selectionID—A string of characters that contains the category and cart number of the selection from the broadcast station automation system. These two pieces of data combined identify the selection in the automation system. These two pieces of information are combined into one string and separated by a forward-slash (“/”). The category comes first, followed by the cart number.

Example: S01/0865
stationcallsign—Radio Station personnel creates the template including a secondary production schedule for a given time period. Production system template commands are contained within this schedule.

The template instructions are exported to a text file on the file system. The software link system, while monitoring for new log export files, discovers the new export file and reads it from the file system and sends a log export file to a broadcast station automation system API via the HTTP interface. The connection is left open so that the broadcast automation system server can send information back, read the template commands from the export file, and replaces the necessary commands with placeholder files, which the software link will later change with the feed clips. The updated export file (with new placeholders) is sent back to the software link system 10 application through the still-open HTTP connection, which then closes the connection.

The secondary production creation system of the present invention system 10 sends the new export feed clip file back to the file system so that the broadcast station automation system can import it into a template which it creates or alternatively it is incorporated into a template as the secondary production and distributed or published as directed by the radio station system.

The system of the present invention includes analytics 426, meaning the ability to tailor the criteria for the production process as to the audience make-up or complexion, demographic, geolocation and participation value, as well as content based considerations, such as flow and provider identity. It also provides security measures to maximize both the data security of the internal automation system of the provider and the flow of information via the social media to the audience members.

The analytics 426 referred to above are part of a clearance component 131 of the analytic component 120 of the system. The analytics can act to filter the dynamic content through an analysis of the meta-data, the transcription, and the fingerprint of the audio. Digital fingerprints are compact digital representations of a media content item (or a segment of a media content item) extracted from a media content item (audio or video) which represent characteristics or features of the media content item with enough specificity to uniquely identify the media content item. Original media content items (e.g., known works) may be registered to the identification service, which may include generating a plurality of segments of the original media content item. Digital fingerprints may then be generated for each of the plurality of segments. Fingerprinting algorithms encapsulate features such as frame snippets, motion and music changes, camera cuts, brightness level, object movements, loudness, pitch, brightness, spectral bandwidth, energy in one or more spectral bands, spectral steadiness, Mel-frequency cepstral coefficients (MFCCs), and so on. The fingerprinting algorithm that is used may be different for audio media content items and video media content items. Additionally, different fingerprinting algorithms may be used to generate digital fingerprints usable to identify a copy of a known work and to generate digital fingerprints usable to identify a cover of a known work. Digital fingerprints generated for a registered work are stored along with content metadata in a repository such as a database. Digital fingerprints can be compared and used to identify media content items even in cases of content modification, alteration, or obfuscation (e.g., compression, aspect ratio changes, re-sampling, change in color, dimensions, format, bitrates, equalization) or content degradation (e.g., distortion due to conversion, loss in quality, blurring, cropping, addition of background noise, etc.) in embodiments. Additionally, or alternatively, digital fingerprints may be usable to identify covers of known media content items.

The digital fingerprint (or multiple digital fingerprints) of the unknown media content item may be compared against the digital fingerprints of all known works registered with a licensing service. In some embodiments, media identifier applies an unknown media content item, one or more segments of the unknown media content item, set of features of the unknown media content item, or digital fingerprint(s) of the unknown media content item to a trained machine learning profile. The trained machine learning profile may then classify the unknown media content item as music or as not music. If the unknown media content item is classified as containing music, the media identifier may compare digital fingerprints of the unknown media content item to digital fingerprints of known works that also contain music. This may reduce the processing resources utilized to match the digital fingerprint. Once the digital fingerprint of the received media content item has matched an instance of a known work, the media content item is identified as being a copy of the known work.

In the event that an external identification service is used, it may determine one or more actions to take with regards to the media content item that has been identified. For example, the media content item may be tagged as being the known work, advertising may be applied to the media content item and licensing revenues may be attributed to the owner of the rights to the known work (e.g., by licensing logic 162), the media content item may be removed from the media content sharing platform, and so on. In some instances, the media identifier 160 may be hosted by a different server computing device than the server computing device 150. The representations and identification may be based upon feature vectors, a spectral representation of the unknown work, the text output of a speech recognition system, musical score produced by a music transcription system, or a bit calculated key method, such as MDS hash, as are known in the art.

An unidentified media content item may be received by a processing device. A set of features of the unidentified media content item may be determined. Metadata associated with the unidentified media content item may be determined. A first similarity between the metadata associated with the unidentified media content item and additional metadata associated with a known media content item from a media content repository may be determined. A second similarity between the set of features of the unidentified media content item and an additional set of features associated with the known media content item may be determined. The unidentified media content item may be identified as a cover of the known media content item based on the first similarity and the second similarity by the processing device.

The media content identification service may determine features for the unidentified media content item. The media content identification service may determine metadata associated with the unidentified media content item. The media content identification service may determine a first similarity between the metadata of the unidentified media content item and additional metadata associated with a known media content item of a plurality of media content items from a media content repository. The media content identification service may determine a second similarity between the determined set of features of the unidentified media content item and an additional set of features association with the known media content item. The media content identification service may identify the unidentified media content item as a cover of the known media content item based upon the first similarity of the metadata and the second similarity of the set of features.

The media content identification service may further update the metadata of the unidentified media content item to include cover information that identifies the unidentified media content item as a cover of the known media content item. A cover version or cover is a new performance or recording of a previously performed or recorded musical composition.

The metadata within the unidentified media content item may include a metadata description attribute that describes the unidentified media content item.

The media content identification service may further compare the metadata associated with the unidentified media content item with additional metadata associated with two or more of the plurality of known media content items. The media content identification service may determine similarity values for each of the two or more of the plurality of known media content items based on the comparison. The similarity values may represent a similarity between metadata associated with a known media content item and the metadata associated with the unidentified media content item. The media content identification service may determine a set of known media content items that have similarity values that meet or exceed a similarity threshold. The media content identification service may compare the set of features of the unidentified media content item to sets of features of each of the known media content items in the set of known media content items.

The media content identification service may, when determining the first similarity between the metadata associated with the unidentified media content item and the additional metadata associated with the known media content item, normalize the metadata of the unidentified media content item to generate a normalized descriptive text for the unidentified media content item. The media content identification service may compare the normalized descriptive text of the unidentified media content item with normalized descriptive text of the known media content item. The normalized descriptive text of the known media content item may be based on the additional metadata associated with the known media content item. The media content identification service may generate a similarity score between the normalized descriptive text of the unidentified media content item and the normalized descriptive text of the known media content item. The media content identification service may determine that the similarity score is above a similarity threshold.

List of Itemized Example Embodiments of the Technology Disclosed:

A method according to a first example embodiment of the technology disclosed for creating an on-demand or down-loadable web-cast incorporating audio feed from a broadcast radio station having a radio automation system and administrator, the method comprising: encoding the audio feed; receiving, at a production system, the encoded audio feed; editing the encoded audio feed; and creating a secondary production by combining the audio clip with additional material.

In a method according to a second embodiment, the production system in the first example embodiment above is further provided with pre-selected instructions and the editing in the above-mentioned first embodiment is determined by the pre-selected instructions and includes the actions of decoding the encoded feed, parsing, or indexing, an audio clip from the decoded feed and combining the audio clip with additional material to create the secondary production.

In a method according to a third embodiment, the secondary production in any of the first and second embodiments above is distributed to at least one of the broadcast radio station and to social media for listening or viewing by an audience member.

In a method according to a fourth embodiment, a tone generator is activated to emit a tone that encodes the audio feed at a time selected by the broadcast radio station administrator, thereby creating the encoded audio feed.

In certain aspects, the technology disclosed describes a production creation system for creating and providing a downloadable secondary production to a presentation device of a user comprising: a capture system that captures a live feed stream and including a microphone or audio source encoder having an on control and an off control that captures a live feed stream and is recorded in feed segments initiated by the on control and ended by the off control, a decoder which marks a segment of the feed stream, and a display screen which displays a wave form of the marked feed segment; a production system linked through the internet to the capture system and which receives the marked feed stream from the capture system and includes a machine having machine readable code to enable the machine to one or more of receive, decode, store, catalog and manipulate the marked feed stream segment in accordance with a set of user enabled production instructions, where the manipulation by the production system includes parsing the marked feed stream into a feed clip and incorporating the feed clip into a secondary production by adding additional material, and transmitting the secondary production to a distribution system; and a distribution system comprising a machine with machine readable code which is linked, e.g. via an IP network such as the internet, to the production system and which is configured to distribute the secondary production in accordance with user enabled instruction in accordance with a set of user enabled distribution instructions, whereby the secondary production is available for download or upload or streamed to a user device.
1. A production creation system for creating and providing a downloadable secondary production to a presentation device of a user for an intended use comprising: a capture system that captures a live feed stream and including a microphone or audio source encoder having an on control and an off control that captures a live feed stream and is recorded in feed segments initiated by the on control and ended by the off control, a decoder which has an activation component to which marks a segment of the feed stream, and a display screen which displays a wave form of the marked feed segment; a production system linked through the internet to the capture system and which receives the marked feed stream from the capture system and includes metadata for the feed stream and includes a machine having machine readable code to enable the machine automatically to one or more of receive, decode, store, catalog and manipulate the marked feed stream segment in accordance with a set of user enabled production instructions, where the manipulation by the production system includes parsing the marked feed stream into a feed clip, reviewing the metadata to determine if there is copyrighted material, and if so, determining if it is unauthorized for the intended use and then eliminating the copyrighted material, and incorporating the copyright free content of the feed clip into a secondary production, and transmitting the secondary production to a distribution system; the distribution system comprising a machine with machine readable code which is linked via IP network including the internet to the production system which distributes the secondary production in accordance with a set of user enabled distribution instructions whereby the secondary production is available for download or upload or streamed to a user device.
2. A production creation system for creating a secondary production available to a user device comprising: a capture system that captures a feed stream having an audio or a video component; a marker system linked to the capture system and which has an encoder which marks a segment of the feed stream including making a waveform of the feed stream as a fingerprint; a production system linked to the marker system and which receives the marked feed stream from the capture system and includes a machine having machine readable code to enable the machine to automatically evaluate the fingerprint to de-select content which is subject to unauthorized use and further to perform one or more of receive, decode, store, catalog and manipulate, the marked feed stream segment in accordance with a set of user enabled production instructions, where the manipulation by the production system includes parsing the marked feed stream into a feed clip and incorporating the feed clip into a secondary production to transmitting the secondary production to a distribution system; the distribution system comprising a machine with machine readable code which is linked via an IP network to the production system and which distributes the secondary production in accordance with a set of user enabled distribution instructions whereby the secondary production is available for download or streamed to a user device.
3. A system for analyzing content consumption on a user device of a created secondary production comprising: a capture system that captures a feed stream having an audio or a video component; a marker system linked to the capture system and which has an encoder which marks a segment of the feed stream; a production system linked to the marker system and which receives the marked feed stream from the capture system and includes a machine having machine readable code to enable the machine to act on the marked feed stream segment in accordance with a set of user enabled production instructions, where the manipulation by the production system includes parsing the marked feed stream into a feed clip and incorporating the feed clip into a secondary production to transmitting the secondary production to a distribution system; a content insertion system including a machine having machine readable code and which is linked to the production system and which automatically selectively incorporates additional content to the secondary production according to a set of user enabled content insertion instruction and which accounts for each instance of insertion of additional content; the distribution system comprising a machine with machine readable code which is linked via IP network to the production system which distributes the secondary production to a variety of individual media platforms in accordance with a set of user enabled distribution instructions which includes instructions that are specific to the individual media platforms as to the use of copyrights and whereby the secondary production is available for download or streamed to a user device; and wherein the accounting by the content insertion system of the incorporation of additional content is aggregated to analyse content consumption.
24. A system for creating an on-demand or down-loadable web-cast incorporating microphone supplied audio feed from a broadcast radio station having a radio automation system and administrator, and for listening or viewing on the device of an audience member comprising: an encoder having a display and a touch activated mechanism which activates a tone generator to emit a tone that encodes the audio feed at a time as selected by the broadcast radio station administrator to create an encoded audio feed; a production system that receives the encoded audio feed by means of the radio automated system which stores and edits the encoded audio feed, the editing being determined by pre-selected instructions including instructions to if the material is within defined parameters and which are stored in a template by the administrator and including decoding the encoded feed, parsing an audio clip from the decoded feed, and combining the audio clip with additional material to create a secondary production; and distributing the secondary production to the broadcast radio station and to social media for listening or viewing by the audience member.

While in accordance with the patent statutes the best mode and preferred embodiment have been set forth, the scope of the invention is not limited thereto, but rather by the scope of the attached claims.

What is claimed is:

1-4. (canceled)

5. A system for analyzing content consumption incorporated into a created secondary production comprising:
a capture system that captures a feed stream;
a marker system linked to the capture system and which has an encoder which marks a segment of the feed stream;
a production system linked to the marker system and which receives the marked feed stream from the capture system including metadata for the feed stream and includes a machine having machine readable code to enable the machine to analyze the metadata to determine if the feed stream includes unauthorized copyrighted material and further to one or more of receive, decode, store, catalog and manipulate, the marked feed stream segment in accordance with a set of user enabled production instructions, where the manipulation by the production system includes parsing the marked feed stream into a feed clip and incorporating the feed clip into a secondary production to transmitting the secondary production to a distribution system;
a content insertion system which is linked to the production system and which incorporates additional content to the secondary production;
the distribution system comprising a machine with machine readable code which is linked via IP network to the production system which distributes the secondary; and
an analytic system linked to the distribution system which accounts for content insertion into the secondary production.

6. A system for analyzing content consumption incorporated into a created secondary production as set forth in claim 5 which can be used to validate at least one of the quantity of use or another characteristic of use or of users of the of the additional content on a case by case basis.

7. A system for analyzing content consumption incorporated into a created secondary production as set forth in claim 5, wherein the content insertion system inserts advertising material or metadata.

8. A production creation system as set forth in claim 5, wherein the segments are marked using an energy pulse.

9. A production creation system as set forth in claim 8, wherein the segments are marked using an inaudible tone.

10. A production creation system as set forth in claim 5, wherein the capture system comprises hardware and software which resides at a broadcast station.

11. A production creation system as set forth in claim 10, wherein the capture system comprises a touch-screen with machine readable code to enable the capture system.

12. A production creation system as set forth in claim 10, wherein the distribution system comprises cloud based hardware and software.

13. A production creation system as set forth in claim 5, wherein the distribution system provides a link to the secondary production to a broadcast radio station, and wherein the distribution system provides the secondary production to social media or an audio aggregation site, and wherein the audio aggregation site is one or more of TuneIn, iHeartRadio and iTunes.

14-15. (canceled)

16. A device for processing an audio broadcast captured by a microphone having an on off to define a feed segment from a broadcast radio station with a broadcast automation system comprising:
a device having a display, a encoder including a wave generator which is activated by an activator to mark the feed segment to produce a marked feed segment and to transmit the marked feed segment as a waveform on the broadcast automation system;
a cloud-based production and distribution system which receives the marked feed segment through the broadcast automation system and comprising a machine having machine readable code that is enabled by user generated instructions to review the waveform, to compare it to the waveforms of copyrighted material and to manipulate the marked feed segment by parsing the marked feed segment into an audio clip and to retrievably store the marked feed segment and the audio clip, to automatically incorporate the audio clip in a secondary production, and to distribute the secondary production back to the broadcast automation system.

17. A device as set forth in claim 16, wherein the feed segments are marked using an in-audible tone, and wherein the in-audible tone is above the capabilities of AM or FM broadcast standards.

18. (canceled)

19. A device as set forth in claim 16, wherein the device having the display and the decoder is a capture system further including a microphone and which comprises hardware and software which resides at a production facility.

20. A device as set forth in claim 16, wherein the capture system comprises a touch-screen with machine readable code to enable the capture system, and wherein the user generated instructions are stored in a template, and wherein the feed segments are marked by activating a mechanical or machine simulated button.

21-22. (canceled)

23. A device as set forth in claim 16, wherein the secondary production is provided to social media.

24. (canceled)

25. A method for creating a secondary production, said method comprising:
capturing, by a capture system, a live feed stream having at least an audio component;
marking, by an encoder of a marking system linked to the capture system, a segment of the live feed stream;
providing a set of user enabled production instructions which include look-up instructions regarding copyright authorization in accordance with subsequent transmission and distribution to a production system linked to the capture system;
receiving, by said production system, the marked feed stream from the capture system;
performing, by a machine of said production system having machine readable code, one or more of the actions of decoding, storing, cataloging and manipulating the marked feed stream segment in accordance with said set of user enabled production instructions, wherein the step of performing includes parsing, or indexing, the marked feed stream into a feed clip and incorporating the feed clip into a secondary production; and
transmitting, from said production system, the secondary production to a distribution system.

26. The method of claim 25, further comprising:
incorporating said feed clip into said secondary production by attaching metadata to said feed stream, wherein said metadata is searchable.

27. The method of claim 26, further comprising:
incorporating said feed clip into said secondary production by at least one of combining supplemental content in different format, including video or graphic files, and linking to outside files.

28. The method of claim 25, further comprising:
incorporating said feed clip into said secondary production by including one or more promotional material advertisements using an ad invocation.

29. The method of claim 28, wherein said step of incorporating said feed clip into said secondary production by including one or more promotional material advertisements comprises:
invoking, by said production system, an external advertisement service to provide the production system with at least one promotional material advertisement.

30. The method of claim 29, wherein said external advertisement service is invoked at least partly based on said set of user enabled production instructions provided to said production system.

31. The method according to claim 25, further comprising:
providing a distribution system with a set of user enabled distribution instructions; and
distributing, by said distribution system comprising a machine with machine readable code which is linked via an IP network, said secondary production in accordance with said set of user enabled distribution instructions, whereby the secondary production is available for download, upload or streamed to a user device.

32. The method of claim 25, wherein the defined parameters include one or more characteristics of being free from unauthorized copyrights or sensitive material and falling within an age related rating system.
